(19) United States
(12) Patent Application Publication
(10) Pub. No.: US 2019/0144616 A1
(43) Pub. Date: May 16, 2019

(54) THERMOPLASTIC RESIN COMPOSITION AND METHOD FOR PRODUCING THERMOPLASTIC RESIN COMPOSITION

(71) Applicants: NISSIN KOGYO CO., LTD., Tomi-city, Nagano (JP); SHINSHU UNIVERSITY, Matsumoto City, Nagano (JP)

(72) Inventors: Keiichi KAWAMOTO, Nagano (JP); Kenichi NIIHARA, Nagano (JP); Toru NOGUCHI, Nagano (JP)

(73) Assignees: NISSIN KOGYO CO., LTD., Tomi-city, Nagano (JP); SHINSHU UNIVERSITY, Matsumoto City, Nagano (JP)

(21) Appl. No.: 16/087,898

(22) PCT Filed: Feb. 28, 2017
(86) PCT No.: PCT/JP2017/008012

§ 371 Date: Sep. 24, 2018

(30) Foreign Application Priority Data
Mar. 28, 2016 (JP) 2016-064125

(51) Int. Cl. C08J 5/00; C08K 3/04; C08K 7/06; C08J 3/20; B29B 7/00; B29B 7/82

(52) U.S. Cl. CPC C08J 5/005; C08K 3/041; C08K 3/04; C08K 7/06; C08J 3/201; B29B 7/002; B29K 2307/04; C08J 2371/10; C08J 2377/00; C08K 2201/014; C08K 2201/011; C08K 2201/003; C08K 2201/004; B29B 7/823

(57) ABSTRACT

A thermoplastic resin composition according to the present invention contains carbon nanotubes and carbon fibers in amounts of 2.8 to 35 parts by mass and 1 to 60 parts by mass, respectively, relative to 100 parts by mass of a thermoplastic resin. In the thermoplastic resin composition, when the content of the carbon nanotubes is 2.8 to 5.3 parts by mass relative to 100 parts by mass of the thermoplastic resin, the content of the carbon fibers is at least 8.3 to 1 part by mass. In the thermoplastic resin composition, when the content of the carbon fibers is 1 to 8.3 parts by mass relative to 100 parts by mass of the thermoplastic resin, the content of the carbon nanotubes is at least 5.3 to 2.8 parts by mass.

### TECHNICAL FIELD

The present invention relates to a thermoplastic resin composition capable of efficiently obtaining a reinforcing effect by carbon fibers and carbon nanotubes, and a method for producing a thermoplastic resin composition.

### BACKGROUND ART

A thermoplastic resin composition in which a thermoplastic resin (polypropylene) is used as a matrix and carbon nanotubes are dispersed therein and a method for producing the same have been proposed (see PTL 1). The thermoplastic resin composition containing the carbon nanotubes had a characteristic that it does not flow even at a temperature exceeding the melting point in a DMA test. However, the characteristic that it does not flow was exhibited when the carbon nanotubes are mixed in an amount of 7 parts by mass or more relative to 100 parts by mass of the thermoplastic resin.

Further, a composite material of carbon fibers and a thermoplastic resin is known. The carbon fibers cannot efficiently obtain a reinforcing effect on the thermoplastic resin unless a sizing agent is used, and the composite material is likely to be brittle.

### CITATION LIST

### Patent Literature

PTL 1: JP-A-2014-141613

### SUMMARY OF INVENTION

### Technical Problem

An object of the present invention is to provide a thermoplastic resin composition capable of efficiently obtaining a reinforcing effect by carbon fibers and carbon nanotubes, and a method for producing a thermoplastic resin composition.

### Solution to Problem

A thermoplastic resin composition according to the present invention is characterized by containing carbon nanotubes and carbon fibers in amounts of 2.8 to 35 parts by mass and 1 to 60 parts by mass, respectively, relative to 100 parts by mass of a thermoplastic resin.

With the use of the thermoplastic resin composition according to the present invention, a reinforcing effect can be efficiently obtained by carbon fibers and carbon nanotubes.

In the thermoplastic resin composition according to the present invention, when the content of the carbon nanotubes is 2.8 to 5.3 parts by mass relative to 100 parts by mass of the thermoplastic resin, the content of the carbon fibers may be at least 8.3 to 1 part by mass.

In the thermoplastic resin composition according to the present invention, when the content of the carbon fibers is 1 to 8.3 parts by mass relative to 100 parts by mass of the thermoplastic resin, the content of the carbon nanotubes may be at least 5.3 to 2.8 parts by mass.

In the thermoplastic resin composition according to the present invention, the carbon nanotubes may have an average diameter of 9 to 30 nm, and the carbon fibers may have an average diameter of 5 to 15 μm.

In the thermoplastic resin composition according to the present invention, the carbon fibers in the thermoplastic resin composition may have an average fiber length of 30 μm to 24 mm.

In the thermoplastic resin composition according to the present invention, the thermoplastic resin composition may express a plateau region at a temperature higher than the melting point of the thermoplastic resin.

A method for producing a thermoplastic resin composition according to the present invention includes:

a mixing step of obtaining a first mixture by kneading a thermoplastic resin, carbon nanotubes, and carbon fibers at a first temperature;

a temperature lowering step of adjusting the temperature of the first mixture to a second temperature; and

a low-temperature kneading step of kneading the first mixture at the second temperature, and is characterized in that

the first temperature is a temperature higher than the second temperature, and

the second temperature is a range of temperature from a processing region expressing temperature in a storage modulus of the thermoplastic resin composition at around the melting point (Tm° C.) of the thermoplastic resin to a temperature which is 1.06 times (T3° C.×1.06) a plateau region expressing temperature (T3° C.) in the storage modulus.

With the use of the method for producing a thermoplastic resin composition according to the present invention, a thermoplastic resin composition in which the wettability between the carbon fibers and the thermoplastic resin is improved can be obtained.

In the method for producing a thermoplastic resin composition according to the present invention, in the mixing step, the carbon nanotubes and the carbon fibers in amounts of 2.8 to 35 parts by mass and 1 to 60 parts by mass, respectively, relative to 100 parts by mass of the thermoplastic resin, may be mixed.

In the method for producing a thermoplastic resin composition according to the present invention, when the content of the carbon nanotubes in the first mixture is 2.8 to 5.3 parts by mass, the content of the carbon fibers may be at least 8.3 to 1 part by mass.

In the method for producing a thermoplastic resin composition according to the present invention, when the content of the carbon fibers in the first mixture is 1 to 8.3 parts by mass, the content of the carbon nanotubes may be at least 5.3 to 2.8 parts by mass.

In the method for producing a thermoplastic resin composition according to the present invention, the carbon nanotubes may have an average diameter of 9 to 30 nm, and the carbon fibers may have an average diameter of 5 to 15 μm.

### BRIEF DESCRIPTION OF DRAWINGS

FIG. 1 is a schematic view for illustrating a method for producing a thermoplastic resin composition of this embodiment.

FIG. 2 is a schematic view for illustrating the method for producing a thermoplastic resin composition of this embodiment.

FIG. 3 is a graph showing a relationship between a storage modulus and a temperature for illustrating a method for obtaining a range of a second temperature.

FIG. 4 is an electron micrograph of a tensile fractured surface of a sample of Example 11.

FIG. 5 is an electron micrograph of a tensile fractured surface of a sample of Comparative Example 10.

FIG. 6 is a graph showing a relationship between a storage modulus of a sample of Example 17 and a temperature.

### DESCRIPTION OF EMBODIMENTS

Hereinafter, preferred embodiments of the present invention will be described in detail with reference to the drawings. Note that the embodiments described below are not intended to unduly limit the content of the invention described in the claims. Further, all the configurations described below are not necessarily essential components of the invention.

### A. Thermoplastic Resin Composition

A thermoplastic resin composition of this embodiment will be described.

The thermoplastic resin composition according to this embodiment is characterized by containing carbon nanotubes and carbon fibers in amounts of 2.8 to 35 parts by mass and 1 to 60 parts by mass, respectively, relative to 100 parts by mass of a thermoplastic resin.

According to the thermoplastic resin composition, a reinforcing effect is efficiently obtained by the carbon fibers and the carbon nanotubes. More specifically, by constructing a special spatial structure in the thermoplastic resin composition with the carbon fibers and the carbon nanotubes, even if the content of the carbon nanotubes is low, a reinforcing effect is efficiently obtained. It has not yet been elucidated at present what such a spatial structure is specifically like. However, a reinforcing effect is obtained only by mixing a small amount of carbon nanotubes even if the content of carbon fibers is the same, and therefore, it is considered that the carbon fibers and the carbon nanotubes construct the spatial structure capable of obtaining a reinforcing effect in collaboration with each other.

In particular, carbon fibers have low wettability with a thermoplastic resin, and also hardly obtain a reinforcing effect as a composite material. In general, carbon fibers improve their wettability with a thermoplastic resin by being subjected to a surface treatment according to the type of the thermoplastic resin.

According to this embodiment, even in the case of using carbon fibers which are not subjected to a surface treatment for improving the wettability with a thermoplastic resin, the wettability of carbon fibers with a thermoplastic resin is remarkably improved by mixing a predetermined amount of carbon nanotubes in the thermoplastic resin. More specifically, high wettability between the carbon fibers and the thermoplastic resin in which the carbon nanotubes are mixed is realized.

High wettability between the carbon fibers and the thermoplastic resin in which the carbon nanotubes are mixed (hereinafter referred to as “matrix material”) in the thermoplastic resin composition can be confirmed by observing a fractured surface of a sample after a tensile test with an electron microscope. As described in the below-mentioned Examples, high wettability can be confirmed from an appearance that the sample is stretched in a state where the matrix material is adhered around the carbon fibers on the fractured surface.

Further, high wettability between the carbon fibers and the matrix material in the thermoplastic resin composition can be confirmed by measuring the temperature dependence of a storage modulus in a dynamic viscoelasticity test. In general, when a dynamic viscoelasticity test is performed, a thermoplastic resin flows at around its melting point and the storage modulus rapidly drops. However, the thermoplastic resin composition of this embodiment does not flow at a temperature higher than the melting point of the thermoplastic resin used in the matrix material (hereinafter, referred to as “the thermoplastic resin composition does not flow”). That is, the storage modulus in a dynamic viscoelasticity test of the thermoplastic resin composition expresses a region in which a change is small even at a temperature exceeding the melting point, and a graph of the temperature dependence of the storage modulus has a plateau region at a temperature exceeding the melting point.

In order to express a plateau region, the carbon fibers and the carbon nanotubes should be mixed at predetermined amounts or more. In the thermoplastic resin composition, when the content of the carbon nanotubes is 2.8 to 5.3 parts by mass relative to 100 parts by mass of the thermoplastic resin, the content of the carbon fibers may be at least 8.3 to 1 part by mass. In the case where the content of the carbon nanotubes is small in this manner, in order to express a plateau region, the content of the carbon fibers needs to be a predetermined amount or more. Specifically, when the content of the carbon nanotubes is 2.8 parts by mass relative to 100 parts by mass of the thermoplastic resin, the content of the carbon fibers needs to be at least 8.3 parts by mass or more, and when the content of the carbon nanotubes is 5.3 parts by mass relative to 100 parts by mass of the thermoplastic resin, the content of the carbon fibers needs to be at least 1 part by mass or more.

Further, in the thermoplastic resin composition, when the content of the carbon fibers is 1 to 8.3 parts by mass relative to 100 parts by mass of the thermoplastic resin, the content of the carbon nanotubes may be at least 5.3 to 2.8 parts by mass. In the case where the content of the carbon fibers is small in this manner, in order to express a plateau region, the content of the carbon nanotubes needs to be a predetermined amount or more. Specifically, when the content of the carbon fibers is 1 part by mass relative to 100 parts by mass of the thermoplastic resin, the content of the carbon nanotubes needs to be at least 5.3 parts by mass or more, and when the content of the carbon fibers is 8.3 parts by mass relative to 100 parts by mass of the thermoplastic resin, the content of the carbon nanotubes needs to be at least 2.8 parts by mass or more.

It is desired that agglomerates of carbon nanotubes which are dispersed are not present in the thermoplastic resin composition. This is because when agglomerates of carbon nanotubes are present therein, they affect the mechanical strength or the like of the thermoplastic resin composition. The absence of agglomerates of carbon nanotubes in the thermoplastic resin composition can be confirmed by observing an arbitrary cross section of the thermoplastic resin composition with an electron microscope. In an electron micrograph, fibrillated and mutually separated carbon nanotubes are shown in a dispersed state on a fractured surface.

Incidentally, the “agglomerate” is a state where carbon nanotubes are entangled with one another like carbon nanotubes as a raw material also in the thermoplastic resin composition, and particularly in the agglomerate, a lot of hollow portions in which the resin does not penetrate between the carbon nanotube and the carbon nanotube are present. The absence of such agglomerates means that the agglomerated carbon nanotubes are disentangled and the carbon nanotubes are dispersed over the entire region in a mutually separated state. The “mutually separated state” refers to a state where a hollow portion is not present between the carbon nanotubes in the thermoplastic resin composition.

According to the thermoplastic resin composition, a reinforcing effect is efficiently obtained by the carbon fibers and the carbon nanotubes, and therefore, the composition can have a high tensile strength and a high elastic modulus without sacrificing ductility.

### A-1. Thermoplastic Resin

As the thermoplastic resin, a melt-moldable thermoplastic resin can be used. Further, as the thermoplastic resin, a thermoplastic resin showing a melting point in a dynamic viscoelasticity test can be used, and for example, a crystalline thermoplastic resin such as polyethylene (PE), polypropylene (PP), polyamide (PA), polyacetal (POM), polybutylene terephthalate (PBT), polyethylene terephthalate (PET), polyphenylene sulfide (PPS) polyether ether ketone (PEEK), polyimide (PI), or a fluororesin (PFA) can be used. Further, even in the case of a thermoplastic resin generally called “amorphous resin”, a thermoplastic resin showing a melting point in a DMA test, for example, polystyrene (PS), polycarbonate (PC), or the like can also be used. In addition, it is also possible to use two or more types of resins listed here in combination, and in such a case, such resins can be used as a mixture of these different resins or a material obtained by melt-blending of different resins or a copolymer.

### A-2. Carbon Nanotubes

The carbon nanotubes may have an average diameter (fiber diameter) of 9 to 30 nm.

The carbon nanotubes have a small average diameter and a large specific surface area, and therefore, if the carbon nanotubes can be fibrillated and dispersed over the entire region, the thermoplastic resin can be effectively reinforced by a small amount of the carbon nanotubes.

The carbon nanotubes can also be subjected to, for example, a surface treatment such as an oxidation treatment for enhancing the reactivity with the thermoplastic resin on the surfaces thereof.

Incidentally, the average diameter and the average length of the carbon nanotubes in the detailed description of the present invention can be obtained by measuring the diameters and the lengths at 200 or more places in an image taken at a magnification of, for example, 5,000 times (the magnification can be appropriately changed according to the sizes of the carbon nanotubes) with an electron microscope, and calculating them as the arithmetic averages.

The carbon nanotubes may be so-called multi-walled carbon nanotubes (MWNT) having such a shape that one sheet of graphite (graphene sheet) of a hexagonal carbon network plane is rolled into a tube. The multi-walled carbon nanotubes may include double-walled carbon nanotubes (DWNT). The carbon nanotubes may include single-walled carbon nanotubes other than the multi-walled carbon nanotubes.

As the carbon nanotubes having an average diameter of 9 nm or more and 30 nm or less, for example, Baytubes C150P and C70P of Bayer Material Science LLC, NC-7000 of Nanocyl, Inc., K-Nanos-100T of Kumho, Inc., etc. can be exemplified.

Further, a carbon material partially having a carbon nanotube structure can also be used. Incidentally, other than the name of “carbon nanotube”, it is also sometimes named “graphite fibril nanotube” or “vapor grown carbon fiber”.

The carbon nanotubes can be obtained by a vapor-phase growth method. The vapor-phase growth method is also called “catalytic chemical vapor deposition (CCVD)”, and is a method for producing carbon nanotubes by vapor-phase thermal decomposition of a gas such as a hydrocarbon in the presence of a metal-based catalyst. More specifically describing the vapor-phase growth method, for example, a floating reaction method in which an organic compound such as benzene or toluene is used as a raw material and an organic transition metal compound such as ferrocene or nickelocene is used as a metal-based catalyst, and these along with a carrier gas are introduced into a reaction furnace in which the temperature is set to a reaction temperature of a high temperature, for example, 400° C. or higher and 1000° C. or lower, and carbon nanotubes are produced in a floating state or on the wall of the reaction furnace, a substrate reaction method in which metal-containing particles previously supported on a ceramic such as alumina or magnesium oxide are brought into contact with a carbon-containing compound at a high temperature, thereby producing carbon nanotubes on a substrate, or the like can be used.

The carbon nanotubes having an average diameter of 9 nm or more and 30 nm or less can be obtained by, for example, a substrate reaction method. The diameters of the carbon nanotubes can be adjusted by, for example, the sizes of the metal-containing particles, the reaction time, or the like.

### A-3. Carbon Fibers

As the carbon fibers, various known types of carbon fibers can be used. As the carbon fibers, for example, carbonaceous fibers, graphite fibers, and the like produced using polyacrylonitrile (PAN), pitch, rayon, lignin, a hydrocarbon gas, or the like can be exemplified. In particular, PAN-based carbon fibers which are excellent in enhancement of mechanical properties when formed into a composite material are preferred. The carbon fibers are preferably short fibers obtained by cutting or fragmenting such as cut fibers, chopped strands, or middle fibers, which can be used in melt-molding. The carbon fibers may have an average diameter of 5 to 15 μm or less, and may have an average diameter of 5 to 10 μm.

The carbon fibers may have an average fiber length of m to 24 mm.

The carbon fibers may be subjected to a surface oxidation treatment. As the surface oxidation treatment, for example, a surface oxidation treatment by an energization treatment, an oxidation treatment in an oxidizing gas atmosphere such as ozone, etc. are exemplified.

Further, the carbon fibers may be carbon fibers in which a coupling agent, a bundling agent, or the like is adhered to the surfaces thereof. As the coupling agent, for example, amino-based, epoxy-based, chlorine-based, mercapto-based, and cation-based silane coupling agents, etc. are exemplified. As the bundling agent, for example, maleic anhydride-based compounds, urethane-based compounds, and acryl-based compounds, epoxy-based compounds, phenol-based compounds, or derivatives of these compounds, etc. are exemplified.

Further, the carbon fibers may be carbon fibers to which a sizing agent is applied. As the sizing agent, for example, polyurethane, epoxy, acryl, phenol, etc. can be exemplified.

### A-4. Content

The content of the carbon nanotubes in the thermoplastic resin composition is 2.8 to 35 parts by mass, and further may be 2.8 to 18 parts by mass relative to 100 parts by mass of the thermoplastic resin. When the content of the carbon nanotubes is less than 2.8 parts by mass, the thermoplastic resin composition flows at around the melting point in a dynamic viscoelasticity test. It is found by the studies conducted by the present inventors so far that in the case where carbon nanotubes alone are mixed, a thermoplastic resin composition does not flow when the content of the carbon nanotubes exceeds around 7 to 8 parts by mass relative to 100 parts by mass of a thermoplastic resin. On the other hand, the thermoplastic resin composition of this embodiment does not flow even if the content of the carbon nanotubes is 2.8 to 8 parts by mass as long as the content of the carbon fibers is at least 8.3 to 1 part by mass.

Here, the “part(s) by mass” represents the outer percentage of an additive or the like relative to the thermoplastic resin or the like, and is sometimes denoted by “phr”, and the “phr” is an abbreviation of “parts per hundred of resin or rubber”.

The content of the carbon fibers is 1 to 60 parts by mass, and further may be 1.1 to 47 parts by mass relative to 100 parts by mass of the thermoplastic resin. When the content of the carbon fibers is 1 part by mass or more, the thermoplastic resin composition has excellent ductility, rigidity, and mechanical properties. On the other hand, when the content of the carbon fibers is 60 parts by mass or less, molding of the thermoplastic resin composition can be performed. Further, the content of the carbon fibers may be 1 to 8.3 parts by mass relative to 100 parts by mass of the thermoplastic resin. Even if the content of the carbon fibers is 1 to 8.3 parts by mass, the thermoplastic resin composition does not flow as long as the content of the carbon nanotubes is at least 5.3 to 2.8 parts by mass.

Here, the phenomenon in which the thermoplastic resin composition does not flow refers to that there is a plateau region at a temperature exceeding the melting point in a DMA test as described above. The phenomenon in which the thermoplastic resin composition does not flow means that the thermoplastic resin is constrained by the carbon nanotubes and the carbon fibers, and it can be presumed that a special spatial structure is formed. The special spatial structure is a state where a matrix surrounded by the fibrillated carbon nanotubes and carbon fibers is constrained by these fibers.

### B. Method for Producing Thermoplastic Resin Composition

A method for producing a thermoplastic resin composition according to this embodiment will be described.

The method for producing a thermoplastic resin composition according to this embodiment includes a mixing step of obtaining a first mixture by kneading a thermoplastic resin, carbon nanotubes, and carbon fibers at a first temperature, a temperature lowering step of adjusting the temperature of the first mixture to a second temperature, and a low-temperature kneading step of kneading the first mixture at the second temperature, and is characterized in that the first temperature is a temperature higher than the second temperature, and the second temperature is a range of temperature from a processing region expressing temperature in a storage modulus of the thermoplastic resin composition at around the melting point (Tm° C.) of the thermoplastic resin to a temperature which is 1.06 times (T3° C.×1.06) a plateau region expressing temperature (T3° C.) in the storage modulus.

### B-1. Mixing Step

In the mixing step, a first mixture is obtained by kneading a thermoplastic resin, carbon nanotubes, and carbon fibers at a first temperature.

The mixing step is a step until feeding of the carbon nanotubes and the carbon fibers in predetermined amounts in the thermoplastic resin is completed and may be preferably a step until an operator recognizes that the carbon nanotubes are mixed in the entire the thermoplastic resin by visual observation.

In the mixing step, the carbon nanotubes and the carbon fibers in amounts of 2.8 to 35 parts by mass and 1 to 60 parts by mass, respectively, relative to 100 parts by mass of a thermoplastic resin may be mixed. Then, when the content of the carbon nanotubes in the first mixture is 2.8 to 5.3 parts by mass, the content of the carbon fibers may be at least 8.3 to 1 part by mass. Further, when the content of the carbon fibers in the first mixture is 1 to 8.3 parts by mass, the content of the carbon nanotubes may be at least 5.3 to 2.8 parts by mass. This is because these become the above-mentioned contents of the respective fibers relative to 100 parts by mass of the thermoplastic resin in the thermoplastic resin composition.

### B-1-1. Kneader

In the mixing step, for example, a kneader such as an open roll, an internal kneader, an extruder, or an injection-molding machine can be used. As the open roll, a known two-roll, three-roll, or the like can be used. The internal kneader is a so-called internal mixer, and a known Banbury type, a kneader type, or the like can be used. As the extruder, the below-mentioned twin-screw kneader can be used. These kneaders to be used in the mixing step desirably have a heating device which heats the mixture during processing.

### B-1-2. First Temperature

The first temperature is a temperature higher than the melting point (Tm) of the thermoplastic resin. The first temperature may be a temperature higher than the melting point (Tm) of the thermoplastic resin by 25° C. or more. The first temperature may be a temperature higher than the melting point (Tm) of the thermoplastic resin by 25° C. or more and 70° C. or less, and may be a temperature higher than the melting point (Tm) by 25° C. or more and 60° C. or less. The first temperature is the actual temperature of the thermoplastic resin during the mixing step, and is not the temperature of a processing device. The molding processing temperature of the thermoplastic resin is generally represented by the set temperature of a processing device, for example, in the case of an extruder or an injection molding machine, the set temperature of a heating cylinder, however, the actual temperature of the resin generally becomes higher than the set temperature of the processing device due to shear heat generation during kneading. The first temperature in this embodiment is a temperature during processing, and therefore, it is desired to measure the actual surface temperature of the resin wherever possible, however, in the case where the measurement cannot be performed, the surface temperature of the resin immediately after taking out the first mixture from the processing device is measured, and the temperature can be determined to be the first temperature. The first temperature is not a temperature immediately after feeding the resin into the processing device, but a temperature during mixing after the carbon nanotubes and the carbon fibers are fed.

In the present invention, the “melting point (Tm)” refers to a melt peak value measured in accordance with JIS K 7121 using differential scanning calorimetry (DSC).

### B-1-3. Open Roll

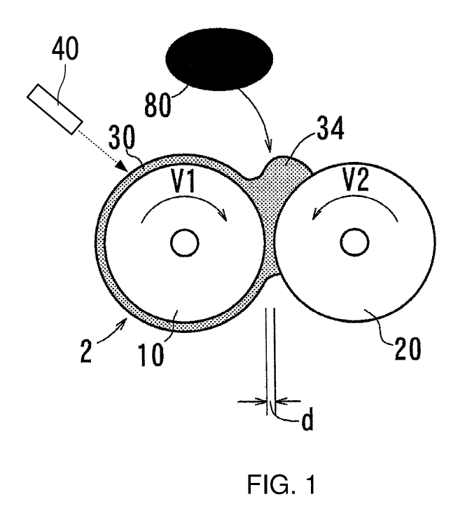

A method which is performed using a two-roll open roll 2 as shown in FIG. 1 will be described. A first roll 10 and a second roll 20 of the open roll 2 are disposed at a predetermined distance d, for example, a distance of 0.5 to 1.5 mm, and rotate forward or reverse at rotational speeds of V1 and V2 in the directions indicated by the arrows. The temperatures of the first roll 10 and the second roll 20 can be adjusted by, for example, a heating unit provided inside, and are set to the first temperature.

As shown in FIG. 1, a plurality of carbon nanotubes and carbon fibers 80 are fed to a bank 34 of a resin (thermoplastic resin) 30 wound around the first roll 10 and kneaded, whereby a first mixture can be obtained. In the mixing step, kneading is performed until the carbon nanotubes and carbon fibers 80 are dispersed in the resin (thermoplastic resin) 30 so as to, for example, eliminate color unevenness in visual observation. As this kneading step, the same step as general kneading for mixing compounding agents (such as carbon nanotubes and carbon fibers) in a thermoplastic resin can be adopted.

However, in this state, the carbon nanotubes in the first mixture are dispersed and present over the entire region in the form of agglomerates as they are, which are the same form as that of the raw material. Therefore, the first mixture has a defect in the material thereof, and for example, when a tensile test or the like is performed, the elongation at break is significantly decreased as compared with that of the thermoplastic resin alone as the raw material.

### B-1-4. Twin-Screw Kneader

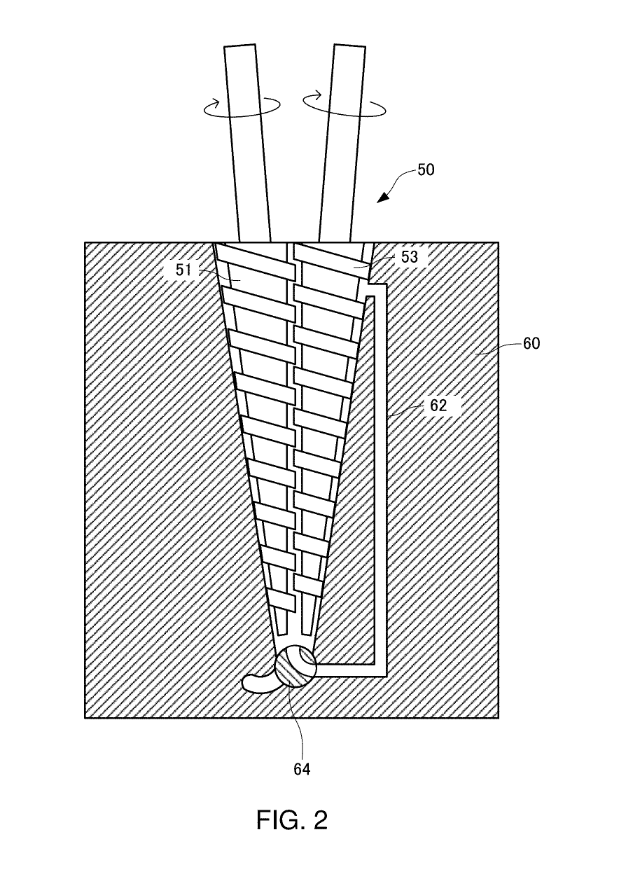

In place of the open roll, a twin-screw kneader 50 as shown in FIG. 2 can be used as the extruder. FIG. 2 is a view schematically showing the method for producing a thermoplastic resin composition using the twin-screw kneader 50. The twin-screw kneader 50 includes two conical-type screws 51 and 53, and a return flow passage 62 and a switching portion 64 formed in a barrel 60. A thermoplastic resin, carbon nanotubes, and carbon fibers are fed from the rear end side (thick side) of the screws 51 and 53 and extruded to the tip end side (thin side), pass through the return flow passage 62 via the switching portion 64 and are sent to the rear end side again, and thus repeatedly kneaded. The switching portion 64 has a mechanism for switching between the return flow passage 62 and a passage for discharging to the outside, and in FIG. 2, a passage is formed from the tip end of the screws 51 and 53 to the return flow passage 62. As the temperature of the mixture kneaded inside, the actual temperature of the mixture is desirably measured by, for example, a thermocouple which protrudes into the passage in the switching portion 64 and comes into contact with the mixture.

Further, as the twin-screw kneader 50, a kneader having high accuracy of the processing temperature and high responsiveness thereto is preferred, and a kneader capable of maintaining a desired temperature range by efficiently dissipating heat by the amount increased due to shear heat during processing is preferred. The twin-screw kneader 50 is preferably capable of not only controlling temperature elevation by a heater, but also controlling forced temperature drop by air blow or cooling water.

### B-2. Temperature Lowering Step

In the temperature lowering step, the temperature of the first mixture is adjusted to a second temperature.

Here, the second temperature will be described.

A general set processing temperature in the mixing step, that is, the set temperature of the processing device is a temperature higher than a temperature recommended as the set processing temperature of a thermoplastic resin in order to sufficiently melt the thermoplastic resin in a short time and rapidly process the resin. Therefore, the processing of the thermoplastic resin is not performed at around the melting point thereof. The surface temperature of the thermoplastic resin during processing becomes higher than such a set processing temperature as described above.

In particular, in the case where a filler, such as carbon nanotubes, is mixed in a thermoplastic resin, as the set processing temperature, it is common that processing is performed at a further higher temperature than the general set processing temperature. Further, the temperature of the first mixture in the mixing step rapidly increases by heat generation due to shear when the content of the carbon nanotubes is increased.

Therefore, it is necessary to lower the temperature of the first mixture for performing a low-temperature kneading step. When kneading is performed, the temperature of the first mixture increases, and therefore, it is generally difficult to lower the temperature while continuing kneading. Due to this, in the temperature lowering step, the first mixture can be allowed to cool to the second temperature by stopping the kneader for a predetermined time, or taking out the first mixture from the kneader after kneading. Further, the first mixture can be actively cooled using a cooling device provided with a cooling mechanism or the like such as an electric fan, a spot cooler, or a chiller. By actively cooling, the processing time can be reduced.

The second temperature is a range of temperature from a processing region expressing temperature in a storage modulus of the thermoplastic resin composition at around the melting point (Tm° C.) of the thermoplastic resin to be used in this production method to a temperature which is 1.06 times (T3° C.×1.06) a plateau region expressing temperature (T3° C.) in the storage modulus.

By a study conducted by the present inventors, it was found that when a dynamic viscoelasticity test (hereinafter referred to as “DMA test”) is performed for the thermoplastic resin composition, it shows a different behavior from that of the thermoplastic resin as the raw material. The storage modulus (E′) of the thermoplastic resin as the raw material rapidly drops at around the melting point (Tm) and the thermoplastic resin flows. However, it was found that the thermoplastic resin composition in which the carbon nanotubes are mixed expresses a plateau region in which the storage modulus (E′) hardly drops, that is, a rubber elastic region like an elastomer even at a temperature exceeding the melting point by dispersing a predetermined amount or more of the carbon nanotubes.

In the low-temperature kneading step, the agglomerated carbon nanotubes are fibrillated, as if they are entangled, and dispersed in the thermoplastic resin by utilizing from a temperature around the melting point to part of this plateau region. In order to set the range of the second temperature, it is necessary to perform a DMA test in advance for a sample of the thermoplastic resin composition having the formulation. A specific procedure is as follows.

First, the first mixture is obtained by performing the mixing step in the above-mentioned B-1 according to a predetermined formulation. Subsequently, a thermoplastic resin composition sample is obtained by performing the same step as the below-mentioned low-temperature kneading step at a temperature around the melting point (for example, in a range from the melting point +10° C. to the melting point +20° C., in which processing can be performed) of the thermoplastic resin to serve as the matrix as the kneading temperature. In this sample, the carbon nanotubes and the like are desirably fibrillated and dispersed, however, even if fibrillation is not sufficient, it is possible to confirm an apparent change in properties at around the inflection point or the plateau region expressing temperature. With respect to this thermoplastic resin composition sample, a DMA test is performed, and a relationship between the storage modulus (E′) and the temperature (° C.) is graphed. When a plateau region is confirmed, this DMA test result is used. Further, when a plateau region cannot be confirmed with this thermoplastic resin composition sample, by setting a temperature around the temperature considered to be the inflection point to the second temperature, a thermoplastic resin composition sample is newly obtained by the above method, and then a DMA test is performed, and a graph is formed in the same manner. Such an operation is repeated until a plateau region is clearly expressed.

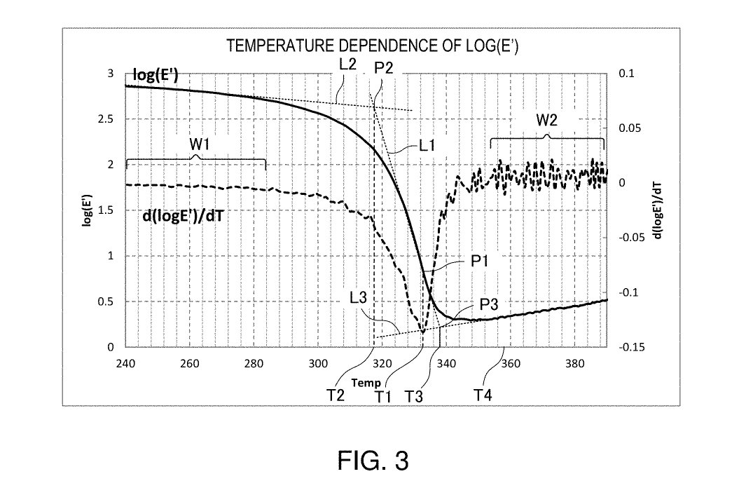

A method for setting the kneading temperature (second temperature) in the low-temperature kneading step will be described using the DMA test result of the below-mentioned thermoplastic resin composition sample of Example 1 prepared using the thus obtained kneading temperature. FIG. 3 is a graph showing the DMA measurement result (the temperature dependence of the storage modulus E′) of the sample of Example 1. In FIG. 3, the horizontal axis represents the temperature (° C.), the vertical axis on the left side represents the logarithmic value (log(E′)) of the storage modulus (E′) and the graph of log(E′) is indicated by a solid line. In FIG. 3, the vertical axis on the right side represents the differential value (d(log(E′))/dT) of the logarithmic value (log(E′)) of the storage modulus (E′), and the graph of d(log(E′))/dT is indicated by a broken line.

The thermoplastic resin of Example 1 is polyether ether ketone (PEEK) having a melting point of 343° C. and the graph of log(E′) has an inflection point P1 at 336° C. The inflection point P1 clearly appears on the graph of d(log(E′))/dT. The inflection point appears at a slightly different temperature by changing the content of CNT or the like. Further, the inflection point also varies depending on the melting point of the thermoplastic resin.

Subsequently, a processing region expressing temperature T2 in the storage modulus (E′) is determined from the graph of log(E′) in FIG. 3. In the graph of log(E′), the slope of the graph is constant at a temperature of 284° C. or lower, and the storage modulus (E′) rapidly drops at around 343° C. which is the melting point (Tm), and the sample starts to flow. In the case of the thermoplastic resin alone in which CNT is not mixed, when the thermoplastic resin starts to flow, the storage modulus (E′) continues to decrease and the thermoplastic resin keeps flowing, however, in the case of the thermoplastic resin composition, the rapid drop of the graph of log(E′) stops to form a plateau region and the thermoplastic resin composition does not flow. A first region W1 with a constant slope in a region at a temperature lower than the melting point before the start of flow clearly appears on the graph of d(log(E′))/dT and is found to be in a range of 240 to 284° C. A temperature at a first intersection point P2 of an extrapolated tangent line L2 of the graph of log(E′) in the first region W1 and a tangent line L1 of the graph of log(E′) at the inflection point P1 is the processing region expressing temperature T2 (317° C.). The processing region expressing temperature T2 is the lower limit temperature at which kneading processing can be performed in the low-temperature kneading step.

Further, a plateau region (rubber elastic region) expressing temperature T3 in the storage modulus (E′) is determined from the graph of log(E′) in FIG. 3. In FIG. 3, the slope is constant in a range of 354 to 390° C. A second region W2 in which the slope beginning from a point where the rapid drop of the graph of log(E′) finishes at a temperature exceeding the melting point is constant clearly appears in the graph of d(log(E′))/dT. A temperature at a second intersection point P3 of an extrapolated tangent line L3 of the graph of log(E′) in the second region W2 and the tangent line L1 of the graph of log(E′) at the inflection point P1 is the plateau region expressing temperature T3.

Incidentally, in the regions (W1 and W2) with a constant slope, a region in which the slope of the graph of log(E′) is constant is assumed to be present in a temperature range of at least 10° C. or more. The plateau region is the second region W2.

The thus obtained temperature which is a temperature higher than the temperature T1 of the inflection point P1 and a temperature at which the viscosity of the thermoplastic resin composition sample is decreased so that the sample does not flow out, for example, a temperature T4 (in FIG. 3, 358° C.) which is 1.06 times (T3° C.×1.06) the plateau region expressing temperature T3 (in FIG. 3, 338° C.) is determined to be the upper limit of the kneading temperature. It is considered that agglomerates of carbon nanotubes and the like can be fibrillated in all sorts of thermoplastic resins as long as the temperature is up to the temperature T4 which is 1.06 times (T3° C.×1.06) the plateau region expressing temperature T3.

If the temperature is within a range from the processing region expressing temperature T2 to the temperature T4 which is 1.06 times (T3° C.×1.06) the plateau region expressing temperature T3, a second mixture has moderate elasticity and moderate viscosity, and therefore, processing can be performed, and also CNT and the like can be fibrillated. According to the study conducted by the present inventors, it is found that as the melting point is higher, the temperature width from T3 to T4 tends to expand. For example, in the case of a polyamide-based resin having a melting point of 120° C., processing can be performed up to a temperature higher than T3 by 7.6° C., and in the case of PEEK having a melting point of 343° C., processing can be performed up to a temperature higher than T3 by 20.58° C.

The lower limit of the kneading temperature in the low-temperature kneading step may be set to a temperature not lower than the inflection point temperature T1 at the inflection point P1. This is because the processing of the second mixture is more facilitated. Incidentally, by changing the content of CNT or the like, the temperature T2 and the temperature T4 become slightly different temperatures.

According to the study conducted by the present inventors, it was assured that agglomerated carbon nanotubes can be fibrillated, as if they are entangled, and dispersed in a thermoplastic resin by performing the low-temperature kneading step using a range from a temperature which is slightly lower than the inflection point temperature T1 to the temperature T4 which is 1.06 times (T3° C.×1.06) the plateau region expressing temperature T3 as the kneading temperature.

The second temperature is a relatively low temperature which is not adopted as the processing temperature for a thermoplastic resin, and particularly becomes a low temperature range which has not been adopted so far as the processing temperature for the second mixture.

The first mixture whose temperature has decreased to the second temperature can be maintained at a predetermined temperature in the range of the second temperature by placing the mixture in, for example, an oven which is set to the second temperature. This is to stabilize the processing quality because the temperature of the first mixture taken out from the kneader continues to drop.

Further, in the case of using commercially available pellets containing carbon nanotubes as the first mixture, a reheating step is needed between the mixing step and the temperature lowering step. The reheating step can be performed by heating to a temperature not lower than the melting temperature of the thermoplastic resin.

### B-3. Low-Temperature Kneading Step

In the low-temperature kneading step, the first mixture is kneaded at the second temperature.

As the first mixture, a mixture obtained by the mixing step in the above-mentioned B-1 can be used.

In the step of kneading the first mixture at the second temperature in the low-temperature kneading step, a device for molding and processing the thermoplastic resin by melting, for example, an open roll, an internal kneader, an extruder, an injection-molding machine, or the like can be used. In the same manner as in the mixing step, a method using the open roll 2 as shown in FIG. 1 will be described. The twin-screw kneader 50 as shown in FIG. 2 may be used.

In this step, a roll distance d between the first roll 10 and the second roll 20 is set to a distance of, for example, 0.5 mm or less, more preferably 0 to 0.5 mm, the first mixture obtained in the mixing step is fed into the open roll 2, and kneading can be performed.

When the surface speed of the first roll 10 is denoted by V1 and the surface speed of the second roll 20 is denoted by V2, the ratio (V1/V2) of the surface speeds of both rolls in this step can be set to 1.05 to 3.00, and further can be set to 1.05 to 1.2. By using such a surface speed ratio, a desired high shear force can be obtained. The first mixture extruded from a narrow gap between the rolls in this manner is largely deformed by a restoring force due to the elasticity of the thermoplastic resin because the second temperature is a range of temperature in which the first mixture has moderate elasticity and moderate viscosity, and the carbon nanotubes can largely move along with the deformation of the thermoplastic resin at this time.

The second temperature is the surface temperature of the first mixture in the low-temperature kneading step and is not the set temperature of the processing device. As also described with respect to the first temperature, it is also desired to measure the actual surface temperature of the resin wherever possible as the second temperature, however, in the case where the measurement cannot be performed, the surface temperature of the resin immediately after taking out the thermoplastic resin composition from the processing device is measured, and the second temperature during processing can be determined based on the temperature.

In the case of the open roll 2, as shown in FIG. 1, the surface temperature can be measured using a non-contact thermometer 40 for the first mixture wound around the first roll 10. The placement of the non-contact thermometer 40 may be any except for the position immediately after passing through the nip and is preferably above the first roll 10. It is desired to avoid the position immediately after passing through the nip because the temperature of the first mixture is an unstable temperature which changes rapidly.

Further, in the case where the surface temperature of the first mixture in the low-temperature kneading step cannot be measured as in an internal kneader, an extruder, or the like, the surface temperature of the thermoplastic resin composition immediately after taking out from the device after kneading is measured and can be confirmed to be within the range of the second temperature. In the case of the twin-screw kneader 50 as shown in FIG. 2, it is desired to measure the actual temperature of the mixture by a temperature sensor using a thermocouple provided, for example, in the flow passage of the switching portion 64.

The low-temperature kneading step may be performed for, for example, 4 to 20 minutes, and further may be performed for 5 to 12 minutes at the second temperature. By ensuring a sufficient kneading time at the second temperature, fibrillation of the carbon nanotubes can be more reliably performed.

The workability of the first mixture is deteriorated by mixing the carbon nanotubes therein, and the temperature of the first mixture becomes further higher than the set temperature of the device due to shear heat generation by kneading the mixture. Therefore, in order to maintain the surface temperature of the first mixture within the second temperature range suitable for the low-temperature kneading step, it is necessary to adjust the temperature by active cooling or the like so that the temperature of the first mixture does not increase by adjusting the temperature of a roll in the case of an open roll. The same also applies to an internal kneader, an extruder, an injection-molding machine, or the like, and by adjusting the set processing temperature of the device through active cooling or the like, the surface temperature of the first mixture can be maintained within the second temperature range for a given time. For example, in the case of an extruder, the set temperature of a heating cylinder is set to a temperature higher than a general processing temperature around a place where the material is supplied, and the temperature is set to a lower temperature than the second temperature in the other zones, whereby the surface temperature of the resin during processing can be adjusted to the second temperature.

The thermoplastic resin composition obtained by the low-temperature kneading step can be subjected to, for example, press processing by being placed in a molding die, or can be molded into a desired shape using a known method for processing a thermoplastic resin by, for example, processing into pellets or the like further using an extruder.

By a shear force obtained in the low-temperature kneading step, a high shear force is applied to the thermoplastic resin, and agglomerated carbon nanotubes are mutually separated and fibrillated as if carbon nanotubes are pulled out one by one by the molecule of the thermoplastic resin and dispersed in the thermoplastic resin. In particular, the thermoplastic resin has elasticity and viscosity in the second temperature range, and therefore can fibrillate and disperse the carbon nanotubes. Then, the thermoplastic resin composition having excellent dispersibility of the carbon nanotubes and dispersion stability thereof (a property in which the carbon nanotubes are hardly reagglomerated) can be obtained.

In the method for producing a thermoplastic resin composition, the carbon nanotubes mixed in the first mixture may have an average diameter of 9 to 30 nm, and the carbon fibers may have an average diameter of 5 to 15 μm. By using the carbon nanotubes having an average diameter of 9 to 30 nm along with the carbon fibers having an average diameter of 5 to 15 μm, an effect such as a reinforcing effect can be obtained.

With the use of the method for producing a thermoplastic resin composition according to this embodiment, a thermoplastic resin composition in which a reinforcing effect is efficiently obtained by carbon fibers and carbon nanotubes can be produced. It is considered that by the method for producing a thermoplastic resin composition, the carbon nanotubes having been present in the form of agglomerates in the thermoplastic resin can be dispersed in a mutually separated state. Therefore, in the thermoplastic resin composition obtained by the method for producing a thermoplastic resin composition, agglomerates of carbon nanotubes are not present, so that destruction due to stress concentration caused by agglomerates does not occur, and also the wettability between the carbon fibers and the thermoplastic resin is high, and thus, the composition can have a high tensile strength and a high storage modulus without sacrificing ductility.

The thermoplastic resin composition has a region which does not flow at a high temperature, and therefore can be applied to, for example, a packing, a sliding member, or the like for an oil exploration machine or a chemical plant to be exposed at a high temperature in the ground.

As described above, while the embodiments of the present invention have been described in detail, it could be easily understood by those skilled in the art that various modifications can be made without materially departing from the novel matter and effects of the invention. Accordingly, all such modifications are intended to be included within the scope of the invention.

### EXAMPLES

Hereinafter, Examples of the present invention will be described, however, the present invention is not limited thereto.

### (1) Preparation of Sample (PEEK)

### (1-1) Preparation of Samples of Examples 1 to 12

Mixing Step: A thermoplastic resin was fed into a desktop twin-screw kneader MC15 (FIG. 2) manufactured by Xplore Instruments and melted. Subsequently, multi-walled carbon nanotubes and carbon fibers were fed into the desktop twin-screw kneader and kneaded at a first temperature, whereby a first mixture was obtained. The set temperature of the desktop twin-screw kneader, the actual measured resin temperature, the screw rotational speed, and the kneading time in Examples 1 to 8 are shown in Table 1, and the set temperature, the actual measured resin temperature, and the screw rotational speed in Examples 9 to 12 are shown in Table 2. Further, the contents (unit: “wt %” and “phr”) in the respective Examples are shown in Tables 3, 5, and 7.

Temperature Lowering Step: The set temperature of the desktop twin-screw kneader was lowered to the set temperature in the low-temperature kneading step shown in Table 1 or 2.

Low-Temperature Kneading Step: The first mixture was kneaded in the desktop twin-screw kneader under the conditions shown in Table 1 or 2.

Extruding Step: A thermoplastic resin composition was extruded from the desktop twin-screw kneader under the conditions shown in Table 1 or 2.

Pressing Step: The thermoplastic resin composition taken out from the twin-screw kneader was placed in a molding die and press-molded at 375 to 385° C., whereby a sample in a sheet form having a thickness of about 0.3 mm was obtained.

### (1-2) Preparation of Samples of Comparative Examples 1 to 10

Each of Comparative Examples 1 and 7 was composed of a thermoplastic resin alone, and therefore, the pressing step was performed by placing resin pellets in a molding die, whereby a sample in a sheet form was obtained. In each of the other Comparative Examples, a sample in a sheet form was obtained in the same manner as in Examples. The contents in the respective Comparative Examples are shown in Tables 4, 6, and 8.

Incidentally, in each Table,
“Thermoplastic resin (A)”: polyether ether ketone (PEEK) 450G manufactured by Victrex, Inc., melting point: 343° C. (ISO 11357), melt viscosity: 350 Pa·s (ISO 11443, 400° C.),
“Thermoplastic resin (B)”: polyether ether ketone (PEEK) 90G manufactured by Victrex, Inc., melting point: 343° C. (ISO 11357), melt viscosity: 90 Pa·s (ISO 11443, 400° C.),
“CNT”: multi-walled carbon nanotubes (MWNT) K-Nanos-100T manufactured by Kumho, Inc., average fiber diameter: 10.5 nm, and
“CF”: carbon fibers, Torayca (registered trademark of Toray Industries, Inc.) cut fiber T010-006 manufactured by Toray Industries, Inc., average fiber diameter: 7 μm, fiber length: 6 mm, without sizing agent, specific gravity of raw yarn: 1760 kg/m³

### (1-3) Second Temperature

The second temperature in Tables 1 and 2 should be set within the range of the second temperature for each sample, and therefore, a sample for measuring the second temperature of each thermoplastic resin composition was obtained by setting the temperature within a range of 353 to 358° C. and within a range of 332 to 337° C. as the second temperature in the low-temperature kneading step and performing the procedure as in the above-mentioned (1-1). With respect to the sample for measuring the second temperature having a formulation of each Example, DMA measurement was performed by the same method as in the below-mentioned (3). Based on the measurement results, a graph of storage modulus (E′) versus temperature was created, and in the case of, for example, the thermoplastic resin A, the inflection point temperature T1 (336° C.), the processing region expressing temperature T2 (317° C.), and the temperature T4 (358° C.) which is 1.06 times (T3° C.×1.06) the plateau region expressing temperature T3 (338° C.) were obtained by the above-mentioned method. The method for determining the range of the second temperature for each sample was as described above, and the temperature dependence of the storage modulus in the DMA measurement of Example 1 was as shown in FIG. 3.

As a result of DMA measurement of each of the samples for measuring the second temperature of Examples 1 to 12, the ranges of the temperatures T2 to T4 of all the samples were within the ranges of the actual measured resin temperature in the low-temperature kneading step shown in Tables 1 and 2.

TABLE 1

| | Actual measured | | | |
|---|---|---|---|---|
| | resin temperature | Rotational speed | | |
| Mixing step | 380° C. | Feeding of resin | Feeding of CF/CNT | Kneading (5 min) |
| | | 40 rpm | 40 rpm | 20 to 150 rpm |

| Low-temperature | 353 to 358° C. | Kneading (8 min) | |
|---|---|---|---|
| kneading step | | 20 to 120 rpm | |
| Extruding step | 380° C. | Temperature elevation | Extrusion |
| | | 20 to 150 rpm | 10 to 80 rpm |

TABLE 2

| | Actual measured | | | |
|---|---|---|---|---|
| | resin temperature | Rotational speed | | |
| Mixing step | 375° C. | Feeding of resin | Feeding of CF/CNT | Kneading (5 min) |
| | | 40 rpm | 40 rpm | 20 to 150 rpm |

| Low-temperature | 332 to 337° C. | Kneading (8 min) | |
|---|---|---|---|
| kneading step | | 20 to 120 rpm | |
| Extruding step | 380° C. | Temperature elevation | Extrusion |
| | | 20 to 150 rpm | 10 to 80 rpm |

### (2) Tensile Test

With respect to the samples of Examples and Comparative Examples, a tensile test was performed according to JIS K 7127 at 23±2° C., a gauge length of 10 mm, and a tensile speed of 10 mm/min using a tensile tester, Autograph AG-X manufactured by Shimadzu Corporation for a specimen punched into a dumbbell shape of JIS K 6251 type 7, and a tensile strength (TS (MPa)), an elongation at break (Eb (%)), and a tensile stress at yield point (σy (MPa)) were measured. The measurement results are shown in Tables 3 to 8.

### (3) DMA Measurement

With respect to the samples of Examples and Comparative Examples, a DMA test (dynamic viscoelasticity test) was performed according to JIS K 7244 at a distance between chucks of 20 mm, a measurement temperature of 20 to 400° C., a temperature elevation rate of 3° C., a dynamic strain of ±0.05%, and a frequency of 1 Hz using a dynamic viscoelasticity tester DMS6100 manufactured by SII for a specimen cut out into a strip shape (40×10×0.3 mm).

Based on these test results, storage moduli (E′) at measurement temperatures of 50° C., 200° C., and 250° C. were measured and shown in Tables 3 to 8. In Tables 3 to 8, the storage moduli are denoted by “E′ (50° C.) (MPa)”, “E′ (200° C.) (MPa)”, and “E′ (250° C.) (MPa)”. Further, in the DMA test, a sample which did not flow at a temperature up to 250° C. is described as “not flow”.

Further, the ratio of change in storage modulus between 50° C. and 200° C. ([E′ (200° C.)−E′ (50° C.)]/E′ (50° C.)×100(%)) was determined. This is for confirming whether or not the change in storage modulus at around Tg (glass transition point) of the thermoplastic resin can be suppressed. This is because the thermoplastic resin composition is actually used in the market at around Tg.

TABLE 3

| | | | Example 1 | Example 2 | Example 3 | Example 4 |
|---|---|---|---|---|---|---|
| Content ratio | Thermoplastic resin A | wt % | 90 | 87.5 | 94 | 92.5 |
| (wt %) | CNT | wt % | 2.5 | 2.5 | 5 | 5 |
| | CF | wt % | 7.5 | 10 | 1 | 2.5 |
| | Total carbon | wt % | 10.0 | 12.5 | 6.0 | 7.5 |
| Content | Thermoplastic resin A | phr | 100 | 100 | 100 | 100 |
| (phr) | CNT | phr | 2.8 | 2.9 | 5.3 | 5.4 |
| | CF | phr | 8.3 | 11.4 | 1.1 | 2.7 |
| Ordinary-state | TS | MPa | 105.0 | 116.6 | 86.0 | 94.6 |
| physical | Eb | % | 7.6 | 5.6 | 9.4 | 7.0 |
| properties | σy | MPa | 114.9 | 120.6 | 102.2 | 102.5 |
| Dynamic | E′ (50° C.) | MPa | 6289 | 6140 | 4454 | 4690 |
| viscoelasticity | E′ (200° C.) | MPa | 796 | 972 | 453 | 666 |
| | E′ (250° C.) | MPa | 692 | 828 | 372 | 366 |

| | | | | |
|---|---|---|---|---|
| flow | not flow | not flow | not flow | not flow |

| | | | | |
|---|---|---|---|---|
| [E′(200° C.) − E′(50° C.)]/E′(50° C.) (%) | −87.3 | −84.2 | −89.8 | −85.8 |

TABLE 4

| | | | Comparative | Comparative | Comparative | Comparative |
|---|---|---|---|---|---|---|
| | | | Example 1 | Example 2 | Example 3 | Example 4 |
| Content ratio | Thermoplastic resin A | wt % | 100 | 95 | 92.5 | 92.5 |
| (wt %) | CNT | wt % | 0 | 5 | 7.5 | 2.5 |
| | CF | wt % | 0 | 0 | 0 | 5 |
| | Total carbon | wt % | 0.0 | 5.0 | 7.5 | 7.5 |
| Content | Thermoplastic resin A | phr | 100 | 100 | 100 | 100 |
| (phr) | CNT | phr | 0.0 | 5.3 | 8.1 | 2.7 |
| | CF | phr | 0.0 | 0.0 | 0 | 5.4 |
| Ordinary-state | TS | MPa | 100.3 | 85.2 | 84.2 | 104.8 |
| physical | Eb | % | 173.1 | 156.3 | 101.3 | 5.0 |
| properties | σy | MPa | 84.5 | 88.8 | 93.1 | 107.7 |
| Dynamic | E′ (50° C.) | MPa | 3376 | 3654 | 4063 | 5802 |
| viscoelasticity | E′ (200° C.) | MPa | 236 | 315 | 426 | 885 |
| | E′ (250° C.) | MPa | 220 | 265 | 332 | 521 |

| | | | | |
|---|---|---|---|---|
| flow | flow | flow | not flow | flow |

| | | | | |
|---|---|---|---|---|
| [E′(200° C.) − E′(50° C.)]/E′(50° C.) (%) | −93.0 | −91.4 | −89.5 | −84.8 |

TABLE 5

| | | | Example 5 | Example 6 | Example 7 | Example 8 |
|---|---|---|---|---|---|---|
| Content ratio | Thermoplastic resin A | wt % | 77.5 | 65 | 65 | 68 |
| (wt %) | CNT | wt % | 2.5 | 5 | 10 | 12 |
| | CF | wt % | 20 | 30 | 25 | 20 |
| | Total carbon | wt % | 22.5 | 35.0 | 35.0 | 32.0 |
| Content | Thermoplastic resin A | phr | 100 | 100 | 100 | 100 |
| (phr) | CNT | phr | 3.2 | 7.7 | 15.4 | 17.6 |
| | CF | phr | 25.8 | 46.2 | 38.5 | 29.4 |
| Ordinary-state | TS | MPa | 143.9 | 154.1 | 155.8 | 145.2 |
| physical | Eb | % | 4.3 | 1.9 | 2.4 | 2.9 |
| properties | σy | MPa | — | — | — | 146.0 |
| Dynamic | E′ (50° C.) | MPa | 9167 | 11801 | 7060 | 12609 |
| viscoelasticity | E′ (200° C.) | MPa | 1489 | 3010 | 3512 | 3975 |
| | E′ (250° C.) | MPa | 1251 | 2212 | 2459 | 2955 |

| | | | | |
|---|---|---|---|---|
| flow | not flow | not flow | not flow | not flow |

| | | | | |
|---|---|---|---|---|
| [E′(200° C.) − E′(50° C.)]/E′(50° C.) (%) | −83.8 | −74.5 | −50.3 | −68.5 |

TABLE 6

| | | | Compar- | Compar- |
|---|---|---|---|---|
| | | | ative | ative |
| | | | Example 5 | Example 6 |
| Content ratio | Thermoplastic resin A | wt % | 70 | 50 |
| (wt %) | CNT | wt % | 0 | 0 |
| | CF | wt % | 30 | 50 |
| | Total carbon | wt % | 30.0 | 50.0 |
| Content | Thermoplastic resin A | phr | 100 | 100 |
| (phr) | CNT | phr | 0.0 | 0.0 |
| | CF | phr | 42.9 | 100.0 |
| Ordinary-state | TS | MPa | 122.3 | 150.2 |
| physical | Eb | % | 2.5 | 2.0 |
| properties | σy | MPa | — | — |
| Dynamic | E′ (50° C.) | MPa | 8277 | 12282 |
| viscoelasticity | E′ (200° C.) | MPa | 1436 | 2678 |
| | E′ (250° C.) | MPa | 1371 | 2352 |
| | flow | | flow | not flow |

| | | |
|---|---|---|
| [E′(200° C.) − E′(50° C.)]/E′(50° C.) (%) | −82.6 | −78.2 |

TABLE 7

| | | | Example 9 | Example 10 | Example 11 | Example 12 |
|---|---|---|---|---|---|---|
| Content ratio | Thermoplastic resin B | wt % | 90 | 75 | 85 | 70 |
| (wt %) | CNT | wt % | 5 | 5 | 10 | 10 |
| | CF | wt % | 5 | 20 | 5 | 20 |
| | Total carbon | wt % | 10 | 25 | 15 | 30 |
| Content | Thermoplastic resin B | phr | 100 | 100 | 100 | 100 |
| (phr) | CNT | phr | 5.6 | 6.7 | 11.8 | 14.3 |
| | CF | phr | 5.6 | 26.7 | 5.9 | 28.6 |
| Ordinary-state | TS | MPa | 110.9 | 136.5 | 119.1 | 146.5 |
| physical | Eb | % | 4.1 | 3.5 | 3.4 | 2.7 |
| properties | σy | MPa | — | — | 119.1 | — |
| Dynamic | E′ (50° C.) | MPa | 5271 | 9243 | 6420 | 10747 |
| viscoelasticity | E′ (200° C.) | MPa | 1203 | 2203 | 1512 | 3334 |
| | E′ (250° C.) | MPa | 813 | 1651 | 1114 | 2268 |

| | | | | |
|---|---|---|---|---|
| flow | not flow | not flow | not flow | not flow |

| | | | | |
|---|---|---|---|---|
| [E′(200° C.) − E′(50° C.)]/E′(50° C.) (%) | −77.2 | −76.2 | −76.4 | −69.0 |

TABLE 8

| | | | Comparative | Comparative | Comparative | Comparative |
|---|---|---|---|---|---|---|
| | | | Example 7 | Example 8 | Example 9 | Example 10 |
| Content ratio | Thermoplastic resin B | wt % | 100 | 95 | 90 | 50 |
| (wt %) | CNT | wt % | 0 | 5 | 10 | 0 |
| | CF | wt % | 0 | 0 | 0 | 50 |
| | Total carbon | wt % | 0 | 5 | 10 | 50 |
| Content | Thermoplastic resin B | phr | 100 | 100 | 100 | 100 |
| (phr) | CNT | phr | 0.0 | 5.3 | 11.1 | 0.0 |
| | CF | phr | 0.0 | 0.0 | 0.0 | 100.0 |
| Ordinary-state | TS | MPa | 79.8 | 81.2 | 95.3 | 125.0 |
| physical | Eb | % | 4.8 | 8.4 | 5.7 | 1.6 |
| properties | σy | MPa | 98.1 | 104.0 | 106.3 | — |
| Dynamic | E′ (50° C.) | MPa | 3401 | 4560 | 4255 | 11488 |
| viscoelasticity | E′ (200° C.) | MPa | 385 | 608 | 830 | 2983 |
| | E′ (250° C.) | MPa | 272 | 438 | 474 | 2435 |

| | | | | |
|---|---|---|---|---|
| flow | flow | flow | not flow | not flow |

| | | | | |
|---|---|---|---|---|
| [E′(200° C.) − E′(50° C.)]/E′(50° C.) (%) | −88.7 | −86.7 | −80.5 | −74.0 |

The following was found from the results of the tensile test shown in Tables 3 to 8.

(a) The samples of Examples 1 to 4 did not flow in the DMA test although the addition amount of the carbon nanotubes was smaller than in Comparative Example 3. Comparative Example 3 did not flow, and Comparative Example 4 in which the content of carbon nanotubes was slightly smaller than in Example 1 flowed. Comparative Example 4 flowed at around Tm although the ratio of change in storage modulus at around Tg was smaller than in Comparative Examples 1 to 3. As compared with Comparative Examples 1 to 3, the samples of Examples 1 to 4 had a lower tensile strength (TS) and a lower elongation at break (Eb), but showed higher values of tensile stress at yield point (y) and storage modulus (E′) at each temperature. As compared with Comparative Example 4, the samples of Examples 1 to 4 had a higher elongation at break (Eb) and yielded in the tensile test. That is, the sample of Example 4 had high flexibility and was not embrittled.

(b) Further, the samples of Examples 5 to 8 had a high tensile strength (TS) and did not flow in the DMA test although the total carbon amount was equivalent to that of Comparative Example 5. The samples of Examples 5 to 8 had an equivalent tensile strength (TS) and an equivalent or higher elongation at break (Eb) although the total carbon amount was smaller as compared with Comparative Example 6. Comparative Example 5 flowed in the DMA test even though the content of the carbon fibers was 30 wt %.

(C) Further, the samples of Examples 9 to 12 did not flow in the DMA test unlike Comparative Examples 7 and 8 and had a small ratio of decrease in storage modulus (E′) at around the melting point (Tm). Further, the samples of Examples 9 to 12 had a higher tensile strength (TS) and a higher storage modulus (E′) at each temperature as compared with Comparative Examples 7 to 9. The samples of Examples 9 to 12 showed a higher elongation at break (Eb) as compared with Comparative Example 10.

### (4) SEM Observation

The tensile fractured surfaces of the sample of Example 11 and the sample of Comparative Example 10 were observed with a scanning electron microscope (hereinafter referred to as “SEM”)

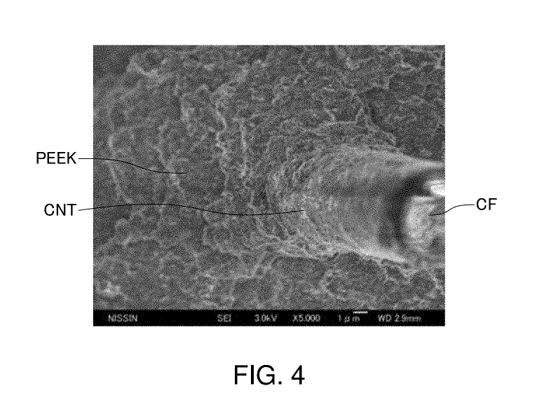

FIG. 4 is an SEM observation photograph of the tensile fractured surface of the sample of Example 11 (magnification: 5000 times). In the drawing, the carbon fiber is denoted by “CF”, the carbon nanotube is denoted by “CNT”, and the thermoplastic resin B is denoted by “PEEK”. The carbon nanotube appeared as a white dot. On the tensile fractured surface of the sample of Example 11, agglomerates of carbon nanotubes could not be confirmed (the SEM photograph for confirming agglomerates of CNT is omitted). Further, on the tensile fractured surface of the sample of Example 11, a matrix (a system containing the thermoplastic resin and the carbon nanotubes) was stretched in the tensile direction in a state where the matrix was in a close contact with the surfaces of the carbon fibers.

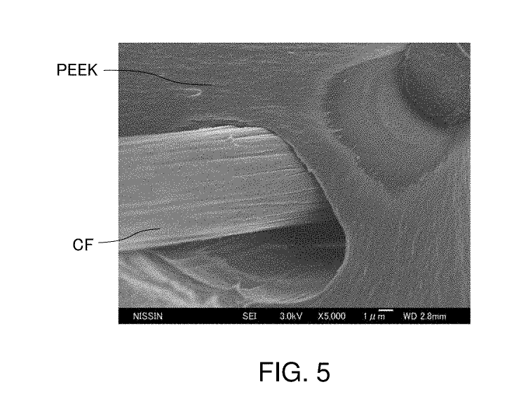

FIG. 5 is an SEM observation photograph of the tensile fractured surface of the sample of Comparative Example 10 (magnification: 5000 times). On the tensile fractured surface of Comparative Example 10, a space was formed between the carbon fiber and the matrix (the thermoplastic resin alone), and also a hole from which the carbon fiber fell out was opened in the matrix.

### (5) Preparation of Sample (PA)

### (5-1) Preparation of Samples of Examples 13 to 29

Specimens (samples) of Examples 13 to 29 were molded by performing a mixing step, a temperature lowering step, a low-temperature kneading step, an extruding step, and injection molding in the same manner as the samples of Examples 1 to 12 under the conditions shown in Table 9 (Examples 13 to 19) and Table 10 (Examples 20 to 29). The conditions for injection molding were as follows: in the case of a thermoplastic resin C, the injection temperature was 280 to 285° C. and the mold temperature was 100 to 125° C., and in the case of a thermoplastic resin D, the injection temperature was 325 to 345° C. and the mold temperature was 140 to 165° C. The contents in the respective Examples are shown in Tables 11, 12, and 14 to 16.

### (5-2) Preparation of Samples of Comparative Examples 11 to 17

Each of Comparative Examples 11 and 15 was composed of a thermoplastic resin alone, and therefore, a specimen (sample) was molded by injection molding of resin pellets as such. In each of the other Comparative Examples, a specimen (sample) was molded in the same manner as in Examples. The contents in the respective Comparative Examples are shown in Tables 13 and 17.

Incidentally, in each Table,
“Thermoplastic resin C”: a polyamide resin (PA66) CM3006-N manufactured by Toray Industries, Inc. (melting point: 265° C.),
“Thermoplastic resin D”: a polyamide resin Genestar (registered trademark of Kuraray Co., Ltd.) PA9T N1000A-M41 manufactured by Kuraray Co., Ltd. (melting point: 300° C.),
“CNT”: multi-walled carbon nanotubes (MWNT) K-Nanos-100T manufactured by Kumho, Inc., average fiber diameter: 10.5 nm, and
“CF”: carbon fibers, Torayca (registered trademark of Toray Industries, Inc.) cut fiber T010-006 manufactured by Toray Industries, Inc., average fiber diameter: 7 μm, fiber length: 6 mm, without sizing agent, specific gravity of raw yarn: 1760 kg/m³

### (5-3) Second Temperature

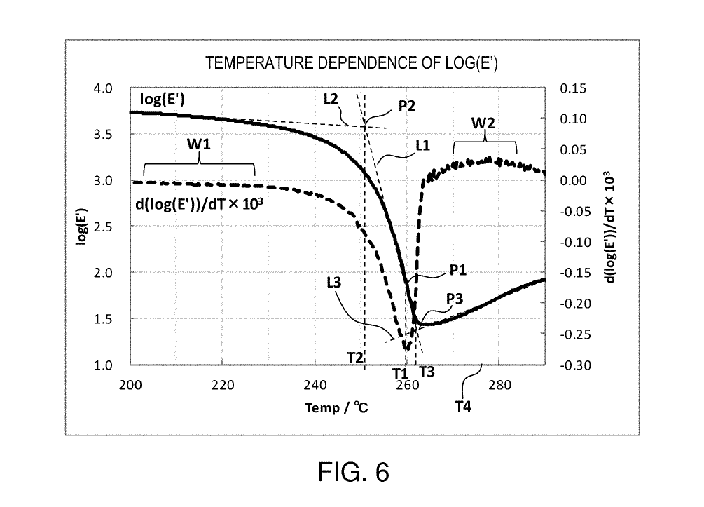

With respect to the sample for measuring the second temperature having a formulation of each Example, DMA measurement was performed by the same method as in the below-mentioned (7). Based on the measurement results, a graph of storage modulus (E′) versus temperature was created, and in the case of, for example, the thermoplastic resin C, the inflection point temperature T1 (260° C.), the processing region expressing temperature T2 (251° C.), and the temperature T4 (277.7° C.) which is 1.06 times (T3° C.×1.06) the plateau region expressing temperature T3 (262° C.) were obtained by the above-mentioned method. The method for determining the range of the second temperature for each sample was as described above, and the temperature dependence of the storage modulus in the DMA measurement of Example 17 was as shown in FIG. 6. Further, in the case of the thermoplastic resin D, the processing temperature expressing temperature T2 was 279° C. and the temperature T4 was 317° C.

As a result of DMA measurement of each of the samples for measuring the second temperature of Examples 13 to 29, the ranges of the temperatures T2 to T4 of all the samples were within the ranges of the actual measured resin temperature in the low-temperature kneading step shown in Tables 9 and 10.

TABLE 9

| | Actual measured | | |
|---|---|---|---|
| | resin temperature | Rotational speed | |
| Mixing step | 285° C. | Feeding of resin/Feeding of CNT | Kneading (3 min) |
| | | 80 rpm | 80 to 120 rpm |
| Low-temperature | 251 to 256° C. | Kneading (10 min) | |
| kneading step | | 30 to 100 rpm | |
| Extruding step | 285° C. | Feeding of CF/Kneading (3 min) | Extrusion |
| | | 50 to 80 rpm | 20 to 100 rpm |

TABLE 10

| | Actual measured | | |
|---|---|---|---|
| | resin temperature | Rotational speed | |
| Mixing step | 322° C. | Feeding of resin/Feeding of CNT | Kneading (3 min) |
| | | 80 rpm | 80 to 120 rpm |
| Low-temperature | 279 to 288° C. | Kneading (10 min) | |
| kneading step | | 30 to 100 rpm | |
| Extruding step | 325° C. | Feeding of CF/Kneading (3 min) | Extrusion |
| | | 50 to 80 rpm | 20 to 100 rpm |

### (6) Tensile Test

With respect to the samples of Examples and Comparative Examples, a tensile test was performed according to JIS K 7161 at 23±2° C., a gauge length of 25 mm, and a tensile speed of 25 mm/min using a tensile tester, Autograph AG-X manufactured by Shimadzu Corporation for a specimen in a dumbbell shape of JIS K 7161 1BA, and a tensile strength (TS (MPa)), an elongation at break (Eb (%)), and a tensile stress at yield point (σy (MPa)) were measured. The measurement results are shown in Tables 11 to 17.

### (7) DMA Measurement

With respect to the samples of Examples and Comparative Examples, a DMA test (dynamic viscoelasticity test) was performed according to JIS K 7244 at a distance between chucks of 20 mm, a measurement temperature of 20 to 330° C., a temperature elevation rate of 2° C., a dynamic strain of ±10 μm, and a frequency of 1 Hz using a dynamic viscoelasticity tester DMS6100 manufactured by SII for a specimen in a strip shape (50×5×2 mm)

Based on these test results, storage modulus (E′) at measurement temperatures of 25° C., 100° C., and 200° C. were measured and shown in Tables 11 to 17. In Tables 11 to 17, the storage modulus are denoted by “E′ (25° C.) (MPa)”, “E′ (100° C.) (MPa)”, and “E′ (200° C.) (MPa)”. Further, in the DMA test, a sample which did not flow at a temperature up to 200° C. is described as “not flow”.

Further, the ratio of change in storage modulus between 25° C. and 200° C. ([E′ (200° C.)−E′ (25° C.)]/E′ (25° C.)×100(%)) was determined. This is for confirming whether or not the change in storage modulus at around Tg of the thermoplastic resin can be suppressed. This is because the thermoplastic resin composition is actually used in the market at around Tg.

TABLE 11

| | | | Example 13 | Example 14 | Example 15 | Example 16 |
|---|---|---|---|---|---|---|
| Content ratio | Thermoplastic resin C | wt % | 90 | 85 | 80 | 70 |
| (wt %) | CNT | wt % | 5 | 5 | 10 | 10 |
| | CF | wt % | 5 | 10 | 10 | 20 |
| | Total carbon | wt % | 10 | 15 | 20 | 30 |
| Content | Thermoplastic resin C | phr | 100 | 100 | 100 | 100 |
| (phr) | CNT | phr | 5.6 | 5.9 | 12.5 | 14.3 |
| | CF | phr | 5.6 | 11.8 | 12.5 | 28.6 |
| Ordinary-state | TS | MPa | 120.6 | 192.6 | 186.5 | 242.5 |
| physical | Eb | % | 4.21 | 3.22 | 3.28 | 2.92 |
| properties | σy | MPa | — | — | — | — |
| Dynamic | E′ (25° C.) | MPa | 5032 | 5766 | 6715 | 10380 |
| viscoelasticity | E′ (100° C.) | MPa | 1669 | 2366 | 4368 | 5269 |
| | E′ (200° C.) | MPa | 890 | 1302 | 3007 | 3721 |

| | | | | |
|---|---|---|---|---|
| flow | not flow | not flow | not flow | not flow |

| | | | | |
|---|---|---|---|---|
| [E′(200° C.) − E′(25° C.)]/E′(25° C.) (%) | −82.3 | −77.4 | −55.2 | −64.1 |

TABLE 12

| | | | Example 17 | Example 18 | Example 19 |
|---|---|---|---|---|---|
| Content ratio | Thermoplastic resin C | wt % | 65 | 60 | 65 |
| (wt %) | CNT | wt % | 5 | 10 | 15 |
| | CF | wt % | 30 | 30 | 20 |
| | Total carbon | wt % | 35 | 40 | 35 |
| Content | Thermoplastic resin C | phr | 100 | 100 | 100 |
| (phr) | CNT | phr | 7.7 | 16.7 | 23.1 |
| | CF | phr | 46.2 | 50.0 | 30.8 |
| Ordinary-state | TS | MPa | 269.7 | 262.9 | 245.2 |
| physical | Eb | % | 2.31 | 1.75 | 2.17 |
| properties | σy | MPa | — | — | — |
| Dynamic | E′ (25° C.) | MPa | 11477 | 12298 | 11758 |
| viscoelasticity | E′ (100° C.) | MPa | 7791 | 7176 | 6840 |
| | E′ (200° C.) | MPa | 5421 | 4581 | 4349 |

| | | | |
|---|---|---|---|
| flow | not flow | not flow | not flow |

| | | | |
|---|---|---|---|
| [E′(200° C.) − E′(25° C.)]/E′(25° C.) (%) | −52.8 | −62.8 | −63.0 |

TABLE 13

| | | | Comparative | Comparative | Comparative | Comparative |
|---|---|---|---|---|---|---|
| | | | Example 11 | Example 12 | Example 13 | Example 14 |
| Content ratio | Thermoplastic resin C | wt % | 100 | 90 | 90 | 70 |
| (wt %) | CNT | wt % | — | 10 | — | — |
| | CF | wt % | — | — | 10 | 30 |
| | Total carbon | wt % | 0 | 10 | 10 | 30 |
| Content | Thermoplastic resin C | phr | 100 | 100 | 100 | 100 |
| (phr) | CNT | phr | — | 11.1 | — | — |
| | CF | phr | — | — | 11.1 | 42.9 |
| Ordinary-state | TS | MPa | 71.7 | 100.5 | 159.9 | 240.1 |
| physical | Eb | % | 21.2 | 7.68 | 2.8 | 3.0 |
| properties | σy | MPa | 86.4 | — | — | — |
| Dynamic | E′ (25° C.) | MPa | 2909 | 2425 | 6226 | 8419 |
| viscoelasticity | E′ (100° C.) | MPa | 730 | 959 | 2593 | 3817 |
| | E′ (200° C.) | MPa | 400 | 557 | 1708 | 2373 |

| | | | | |
|---|---|---|---|---|
| flow | flow | not flow | flow | flow |

| | | | | |
|---|---|---|---|---|
| [E′(200° C.) − E′(25° C.)]/E′(25° C.) (%) | −86.2 | −77.0 | −72.6 | −71.8 |

TABLE 14

| | | | Example 20 | Example 21 | Example 22 | Example 23 |
|---|---|---|---|---|---|---|
| Content ratio | Thermoplastic resin D | wt % | 87.5 | 85 | 85 | 85 |
| (wt %) | CNT | wt % | 10 | 5 | 2.5 | 7.5 |
| | CF | wt % | 2.5 | 10 | 12.5 | 7.5 |
| | Total carbon | wt % | 12.5 | 15 | 15 | 15 |
| Content | Thermoplastic resin D | phr | 100 | 100 | 100 | 100 |
| (phr) | CNT | phr | 11.4 | 5.9 | 2.9 | 8.8 |
| | CF | phr | 2.9 | 11.8 | 14.7 | 8.8 |
| Ordinary-state | TS | MPa | 111.1 | 145.2 | 162.2 | 138.3 |
| physical | Eb | % | 4.3 | 4.0 | 3.8 | 4.2 |
| properties | σy | MPa | — | — | — | — |
| Dynamic | E′ (25° C.) | MPa | 3895 | 6129 | 6132 | 5321 |
| viscoelasticity | E′ (100° C.) | MPa | 3422 | 5603 | 5791 | 4954 |
| | E′ (200° C.) | MPa | 987 | 1935 | 1991 | 1614 |

| | | | | |
|---|---|---|---|---|
| flow | not flow | not flow | not flow | not flow |

| | | | | |
|---|---|---|---|---|
| [E′(200° C.) − E′(25° C.)]/E′(25° C.) (%) | −74.7 | −68.4 | −67.5 | −69.7 |

TABLE 15

| | | | Example 24 | Example 25 | Example 26 |
|---|---|---|---|---|---|
| Content ratio | Thermoplastic resin D | wt % | 80 | 80 | 80 |
| (wt %) | CNT | wt % | 2.5 | 5 | 7.5 |
| | CF | wt % | 17.5 | 15 | 12.5 |
| | Total carbon | wt % | 20 | 20 | 20 |
| Content | Thermoplastic resin D | phr | 100 | 100 | 100 |
| (phr) | CNT | phr | 3.1 | 6.3 | 9.4 |
| | CF | phr | 21.9 | 18.8 | 15.6 |
| Ordinary-state | TS | MPa | 198.1 | 188.3 | 175.4 |
| physical | Eb | % | 2.5 | 2.6 | 2.8 |
| properties | σy | MPa | — | — | — |
| Dynamic | E′ (25° C.) | MPa | 7796 | 7699 | 5660 |
| viscoelasticity | E′ (100° C.) | MPa | 7625 | 7395 | 5252 |
| | E′ (200° C.) | MPa | 3039 | 2937 | 2043 |

| | | | |
|---|---|---|---|
| flow | not flow | not flow | not flow |

| | | | |
|---|---|---|---|
| [E′(200° C.) − E′(25° C.)]/E′(25° C.) (%) | −61.0 | −61.9 | −63.9 |

TABLE 16

| | | | Example 27 | Example 28 | Example 29 |
|---|---|---|---|---|---|
| Content ratio | Thermoplastic resin D | wt % | 70 | 70 | 70 |
| (wt %) | CNT | wt % | 5 | 7.5 | 10 |
| | CF | wt % | 25 | 22.5 | 20 |
| | Total carbon | wt % | 30 | 30 | 30 |
| Content | Thermoplastic resin D | phr | 100 | 100 | 100 |
| (phr) | CNT | phr | 7.1 | 10.7 | 14.3 |
| | CF | phr | 35.7 | 32.1 | 28.6 |
| Ordinary-state | TS | MPa | 202.3 | 189.9 | 178.2 |
| physical | Eb | % | 2.9 | 3.1 | 3.9 |
| properties | σy | MPa | — | — | — |
| Dynamic | E′ (25° C.) | MPa | 9825 | 9247 | 8261 |
| viscoelasticity | E′ (100° C.) | MPa | 8484 | 8100 | 7071 |
| | E′ (200° C.) | MPa | 3388 | 3502 | 3239 |

| | | | |
|---|---|---|---|
| flow | not flow | not flow | not flow |

| | | | |
|---|---|---|---|
| [E′(200° C.) − E′(25° C.)]/E′(25° C.) (%) | −65.5 | −62.1 | −60.8 |

TABLE 17

| | | | Comparative | Comparative | Comparative |
|---|---|---|---|---|---|
| | | | Example 15 | Example 16 | Example 17 |
| Content ratio | Thermoplastic resin D | wt % | 100 | 88 | 90 |
| (wt %) | CNT | wt % | 0 | 12 | — |
| | CF | wt % | — | — | 10 |
| | Total carbon | wt % | 0 | 12 | 10 |
| Content | Thermoplastic resin D | phr | 100 | 100 | 100 |
| (phr) | CNT | phr | 0.0 | 13.6 | 0.0 |
| | CF | phr | 0.0 | 0.0 | 11.1 |
| Ordinary-state | TS | MPa | 85.7 | 92.3 | 150.0 |
| physical | Eb | % | 4.6 | 4.0 | 2.9 |
| properties | σy | MPa | — | — | — |
| Dynamic | E′ (25° C.) | MPa | 2791 | 3362 | 4759 |
| viscoelasticity | E′ (100° C.) | MPa | 2583 | 2437 | 4149 |
| | E′ (200° C.) | MPa | 455 | 628 | 1549 |

| | | | |
|---|---|---|---|
| flow | flow | not flow | flow |

| | | | |
|---|---|---|---|
| [E′(200° C.) − E′(25° C.)]/E′(25° C.) (%) | −83.7 | −81.3 | −67.5 |

(d) The samples of Examples 13 to 19 did not flow in the DMA test. Comparative Example 12 did not flow, but showed lower values of tensile strength (TS) and storage modulus (E′) at each temperature as compared with Examples 13 to 19.

(e) Further, the samples of Examples 20 to 29 did not flow in the DMA test. Comparative Example 16 did not flow, but showed lower values of tensile strength (TS) and storage modulus (E′) at each temperature as compared with Examples 20 to 29.

(f) In addition, agglomerates of carbon nanotubes could not be confirmed on the tensile fractured surfaces of the samples of Examples 13 to 29 subjected to SEM observation in the same manner as in the above-mentioned (4) (the SEM photographs for confirming agglomerates of CNT are omitted). Further, on the tensile fractured surfaces of the samples of Examples 13 to 29, a matrix (a system containing the thermoplastic resin and the carbon nanotubes) was stretched in the tensile direction in a state where the matrix was in a close contact with the surfaces of the carbon fibers.

The present invention is not limited to the above-mentioned embodiments, and further various modification can be made. For example, the present invention includes substantially the same configurations (for example, configurations having the same functions, methods, and results, or configurations having the same objects and effects) as the configurations described in the embodiments. Further, the present invention includes configurations in which a part that is not essential in the configurations described in the embodiments is substituted. Further, the present invention includes configurations having the same effects as in the configurations described in the embodiments, or configurations capable of achieving the same objects as in the configurations described in the embodiments. In addition, the present invention includes configurations in which known techniques are added to the configurations described in the embodiments.

### REFERENCE SINGS LIST

2: open roll, 10: first roll, 20: second roll, 30: second mixture, 34: bank, 40: non-contact thermometer, 50: twin-screw kneader, 51, 53: screw, 60: barrel, 62: return flow passage, 64: switching portion, 80: carbon nanotubes and carbon fibers, d: distance, L1: tangent line of graph of log(E′) passing through inflection point P1, L2: extrapolated tangent line of graph of log(E′) in first region W1, L3: extrapolated tangent line of graph of log(E′) in second region W2, P1: inflection point, P2: first intersection, P3: second intersection, T2: processing region expressing temperature, T3: plateau region expressing temperature, T4: 1.06 times(T3° C.×1.06) the plateau region expressing temperature T3, W1: first region, W2: second region, CF: carbon fibers, CNT: carbon nanotubes, PEEK: thermoplastic resin B, V1, V2: rotational speed

1. A thermoplastic resin composition, comprising carbon nanotubes and carbon fibers in amounts of 2.8 to 35 parts by mass and 1 to 60 parts by mass, respectively, relative to 100 parts by mass of a thermoplastic resin.

2. The thermoplastic resin composition according to claim 1, wherein
when the content of the carbon nanotubes is 2.8 to 5.3 parts by mass relative to 100 parts by mass of the thermoplastic resin, the content of the carbon fibers is at least 8.3 to 1 part by mass.

3. The thermoplastic resin composition according to claim 1, wherein
when the content of the carbon fibers is 1 to 8.3 parts by mass relative to 100 parts by mass of the thermoplastic resin, the content of the carbon nanotubes is at least 5.3 to 2.8 parts by mass.

4. The thermoplastic resin composition according to claim 1, wherein
the carbon nanotubes have an average diameter of 9 to 30 nm, and
the carbon fibers have an average diameter of 5 to 15 μm.

5. The thermoplastic resin composition according to claim 1, wherein
the carbon fibers in the thermoplastic resin composition have an average fiber length of 30 μm to 24 mm.

6. The thermoplastic resin composition according to claim 1, wherein
the thermoplastic resin composition expresses a plateau region at a temperature higher than the melting point of the thermoplastic resin.

7. A method for producing a thermoplastic resin composition, comprising:
a mixing step of obtaining a first mixture by kneading a thermoplastic resin, carbon nanotubes, and carbon fibers at a first temperature;
a temperature lowering step of adjusting the temperature of the first mixture to a second temperature; and
a low-temperature kneading step of kneading the first mixture at the second temperature, wherein
the first temperature is a temperature higher than the second temperature, and
the second temperature is a range of temperature from a processing region expressing temperature in a storage modulus of the thermoplastic resin composition at around the melting point (Tm° C.) of the thermoplastic resin to a temperature which is 1.06 times (T3° C.×1.06) a plateau region expressing temperature (T3° C.) in the storage modulus.

8. The method for producing a thermoplastic resin composition according to claim 7, wherein
in the mixing step, the carbon nanotubes and the carbon fibers in amounts of 2.8 to 35 parts by mass and 1 to 60 parts by mass, respectively, relative to 100 parts by mass of the thermoplastic resin, are mixed.

9. The method for producing a thermoplastic resin composition according to claim 8, wherein
when the content of the carbon nanotubes in the first mixture is 2.8 to 5.3 parts by mass, the content of the carbon fibers is at least 8.3 to 1 part by mass.

10. The method for producing a thermoplastic resin composition according to claim 8, wherein
when the content of the carbon fibers in the first mixture is 1 to 8.3 parts by mass, the content of the carbon nanotubes is at least 5.3 to 2.8 parts by mass.

11. The method for producing a thermoplastic resin composition according to claim 7, wherein
the carbon nanotubes have an average diameter of 9 to 30 nm, and
the carbon fibers have an average diameter of 5 to 15 μm.
